(19) United States
(12) Patent Application Publication
(10) Pub. No.: US 2012/0008697 A1
(43) Pub. Date: Jan. 12, 2012

(54) COMMUNICATIONS NETWORK THAT IS DISTRIBUTED, MODULAR, AND CONFIGURABLE FOR AN ON-BOARD AVIONICS SYSTEM

(75) Inventors: André Emonide, Bouc Bel Air (FR); Serge Germanetti, Marseille (FR)

(73) Assignee: EUROCOPTER, Marignane (FR)

(21) Appl. No.: 13/167,171

(22) Filed: Jun. 23, 2011

(30) Foreign Application Priority Data
Jul. 7, 2010 (FR) 10 02853

(51) Int. Cl. H04L 27/00

(52) U.S. Cl. 375/259

(57) ABSTRACT

A communications network for an on-board avionics system for conveying information between at least one on-board computer (1) and functional members such as sensors (2) and actuators (3), the network including analog links (6, 7) and digital bus links (8, 9a, 9b). At least one modular data concentrator (4) is configurable to digitize data from sensors (2) or to perform digital-to-analog conversions of data for actuators (3). A modular and configurable gateway (5) includes functions of receiving, acquiring, changing digital format, and switching information. Analog links (6, 7) are provided.

### CROSS REFERENCE TO RELATED APPLICATIONS

This application claims the benefit of FR 10 02853 filed on Jul. 7, 2010, the disclosure of which is incorporated in its entirety by reference herein.

### BACKGROUND OF THE INVENTION

(1) Field of the Invention

The invention relates to the general technical field of on-board avionics systems.

The present invention relates more particularly to the architecture of interfaces and of a communications network between the various elements making up an avionics system, in order to optimize information exchanges.

Integrating an avionics and/or mission system from various different pieces of equipment such as a full authority digital engine controller (FADEC), undercarriages, air conditioning, mission equipment, and a radio station, all of which are obtained “off the shelf”, requires their digital or analog interfaces to be used in the states in which they are provided. The communications network for exchanging data on board is thus not uniform. It then becomes difficult to optimize management of such an on-board communications network that is non-uniform and that is incorporated in a complete avionics or mission system.

(2) Description of Related Art

In known systems, a sensor or an actuator is connected directly to a computer, which computer performs the function associated with said sensor or actuator. For example, the conversion of analog or discrete data into digital data, or vice versa, is performed by the computers. The computers must also act as a data gateway in order to convert between digital formats or in order to switch information. This involves a certain number of drawbacks.

The sensors or actuators are often separate and remote from the avionics bays that house the computers, and consequently the cabling that provides the direct connections between the sensors or actuators and the computers is very complex. Such cabling is thus difficult to install, bulky, and represents non-negligible on-board weight.

In addition, the use of the computers is not optimized. This applies in particular when the computers having microprocessors are used for format conversion tasks (analog-to-digital, digital-to-analog, digital-to-digital), or for information switching tasks.

Mention is made of various documents relating to the field of the invention.

Document FR 2 920 623 describes frame switching for an avionics full duplex switched Ethernet (AFDX) network, in order to interconnect pieces of on-board equipment such as on-board computers via dedicated frame switches. A plurality of pieces of equipment (sensors/actuators) send and/or receive data via an AFDX digital network to which the on-board computers are connected. The pieces of equipment are connected to concentrator devices by means of another digital connection network of the CAN bus or ARINC 429 bus type. It is the concentrator devices that are connected to the AFDX digital network in order to send digital data thereto and/or in order to receive digital data therefrom. Those concentrator devices act as conversion gateways between the digital language of the CAN or ARINC 429 digital connection network and the digital language of the AFDX digital network.

Document US 2009/138136 describes a communications system between electronic control units (ECUs) acting via a control network or “local area” network (LAN).

Document GB 2 433 005 describes a protocol converter for avoiding buffer memory overloads and timing problems when transferring data between a device operating under the ARINC 429 standard and an AFDX or Ethernet network.

Document EP 1 538 785 describes an in-flight test installation with a packet style data format using time-dated parameters conveyed in a single format based on an architecture having four data levels.

The invention is defined by the claims.

The invention makes it possible to propose a novel communications network for an on-board avionics system that overcomes the above-mentioned limitations.

Thus, the invention presents an architecture that is distributed over said network so as to integrate a variety of non-uniform communications networks, e.g. based on non-uniform bus technologies such as ARINC 429, Mil Bus 1553, and Ethernet.

Embodiments of the invention form a communications network for an on-board avionics system of an aircraft, conveying information between at least one on-board computer and functional members such as sensors and actuators, and including analog links and digital bus links, the network comprising:

at least one modular and configurable data concentrator for digitizing data from sensors or for performing digital-to-analog conversion on data for actuators or for performing some other digital-to-digital conversion, said concentrator being arranged as close as possible to, i.e. in the proximity of, the sensors and actuators;

at least one modular and configurable gateway including functions for receiving, acquiring, changing digital format, and switching information, said gateway being housed in a protected zone of an aircraft;

analog links between the functional members and the data concentrator;

at least one first digital bus link between the data concentrator and the gateway; and

at least one second digital bus link between the gateway and the on-board computer.

In an embodiment in accordance with the invention, the communications network comprises at least one wireless or carrier-current modulation link for connecting the distribution gateway to one or more control functional members (sensor, data concentrator, or computers).

In an embodiment in accordance with the invention, the data concentrator includes modular elements in the form of configurable elementary and functional bricks.

In an embodiment in accordance with the invention, the gateway includes modular elements in the form of configuration elementary and functional bricks.

In an embodiment in accordance with the invention, the communications network includes a database connected to the gateway and to the data concentrator via a serial link of the digital type, said database being initialized with configuration files, such as XML files.

In an embodiment in accordance with the invention, the digital buses are based on the ARINC 429, Mil Bus 1553, CAN bus, or Ethernet communications standards.

### SUMMARY OF THE INVENTION

The objects given to the invention are also achieved with the help of an on-board avionics system for an aircraft, the system including a communications network as described above.

An advantage of the invention lies in the fact that the computer(s) of the avionics or mission system are reserved exclusively for executing applications software (vehicle management system). A communications network in accordance with the invention consequently off-loads the functions that used in general to be included in the on-board computers, so that the computation power of the microprocessors is reserved to executing applications software.

Another advantage of the communications network in accordance with the invention lies in a significant reduction in the weight of on-board cabling.

Another advantage of the communications network in accordance with the invention lies in using standard products available on the market and thus of being able to benefit from considerable market supply, thereby building up a network that is non-uniform but functional.

Another advantage of the communications network in accordance with the invention lies in the fact that any sensor or actuator can be connected to the communications network. The functions of communication between the various elements connected to the network are provided by using electrical signal transmission over buses or analog links together with gateways or data concentrators, thus making it possible to distribute and store information safely. By having an independent communications network available it is possible to off-load those functions from the computers, which then remain dedicated to executing mission calculations, for example, their main function not being disturbed by acquisition waiting times or by transmission times.

The presence of this network, e.g. including data concentrators in the proximity of sensors or actuators, makes it possible to reduce the overall quantity of cabling in the vehicle fitted with the network.

### BRIEF DESCRIPTION OF THE DRAWINGS

The invention and its advantages appear in greater detail from the context of the following description of an embodiment given by way of illustration with reference to the accompanying figures, in which:

FIG. 1 is a diagrammatic illustration of an embodiment of a communications network in accordance with the invention;

FIG. 2 is a diagrammatic illustration of a detail of an embodiment of a communications network in accordance with the invention including an all-digital gateway;

FIG. 3 is a diagrammatic illustration in greater detail of a gateway of a communications network in accordance with the invention; and

FIG. 4 is a diagrammatic illustration in greater detail of a data concentrator of a communications network in accordance with the invention.

### DETAILED DESCRIPTION OF THE PREFERRED EMBODIMENTS

Elements that are structurally and functionally identical and that are present in more than one of the figures are given the same numerical or alphanumerical references in each of them.

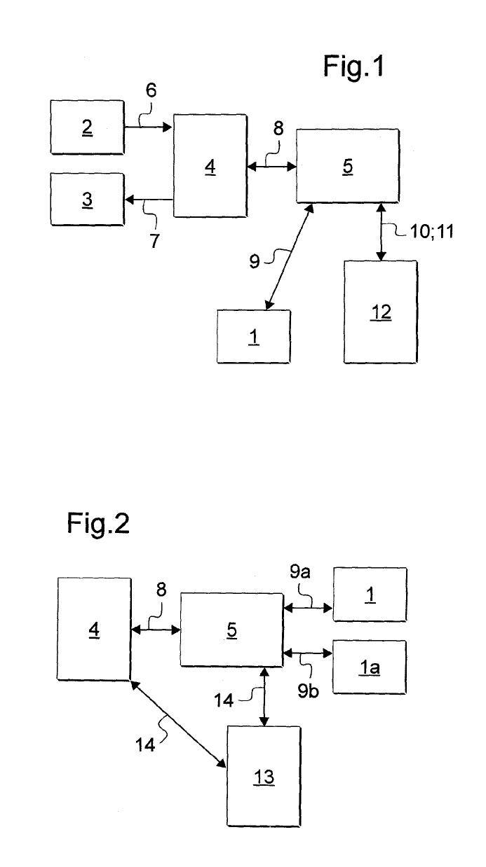

FIG. 1 is a diagrammatic illustration of an embodiment of a communications network in accordance with the invention for an avionics system on board an aircraft. The communications network conveys information between at least one on-board computer 1 and functional members such as sensors 2 and actuators 3.

By way of example, the sensors 2 are connected to the communications network. A network manager ensures safe transmission of data in order to distribute data to all of the equipment concerned and within the desired time periods. The data in question may be electrical or digital information in individual or group form corresponding to measurement values, state values, or setpoint values, which data is exchanged between the various components of an on-board avionics system. These values constitute the functional data exchanged by functions of a system (e.g. a vehicle management system).

The communications network includes analog links and digital bus links.

In an embodiment in accordance with the invention, the digital buses are based on the ARINC 429, Mil Bus 1553, CAN bus, or Ethernet communications standards.

The communications network also includes at least one data concentrator 4 that is modular and configurable in order to digitize data from the sensors 2 or to perform digital-to-analog data conversion for the actuators 3.

The communications network also includes at least one gateway 5 that is modular and configurable, including functions of receiving, acquiring, changing digital format, and switching information.

Analog links 6, 7 are provided between the functional members, e.g. the sensors 2 and the actuators 3, and the data concentrator 4.

The communications network also includes a first digital bus link 8 between the data concentrator 4 and the gateway 5.

A second digital bus link 9 is provided between the gateway 5 and the on-board computer 1.

In an embodiment in accordance with the invention, the communications network includes at least one wireless link 10 or carrier-current modulation link for connecting the gateway 5 to one or more control members 12 (sensor, data concentrator, or computer).

FIG. 2 is a diagrammatic illustration showing a detail of an embodiment of a communications network in accordance with the invention including an all-digital gateway 5.

The gateway 5 serves to manage communication on a non-uniform network of digital buses. Thus, the first digital bus link 8 is a bus based on the ARINC 429 standard connecting the gateway 5 to a data concentrator (not shown in this figure).

The second digital bus link 9 is duplicated in this embodiment, with a bus based on the Mil Bus 1553 standard given reference 9a, connecting the on-board computer 1 to the gateway 5, and an Ethernet link 9b connecting an additional on-board computer 1a to the gateway 5.

In an embodiment in accordance with the invention, the communications network includes a database connected to the gateway 5 and to the data concentrator 4 via respective digital type serial links 14.

The database 13 is initialized by initialization files such as XML files. These XML initialization files serve for example to define configuration or reconfiguration parameters for each piece of equipment, e.g. the data concentrator 4 and the gateway 5.

The data concentrators 4 and the gateways 5 may thus receive configuration files generated by the database and transmitted by means of the digital buses providing the links between the various components, thus enabling the network to reconfigure automatically.

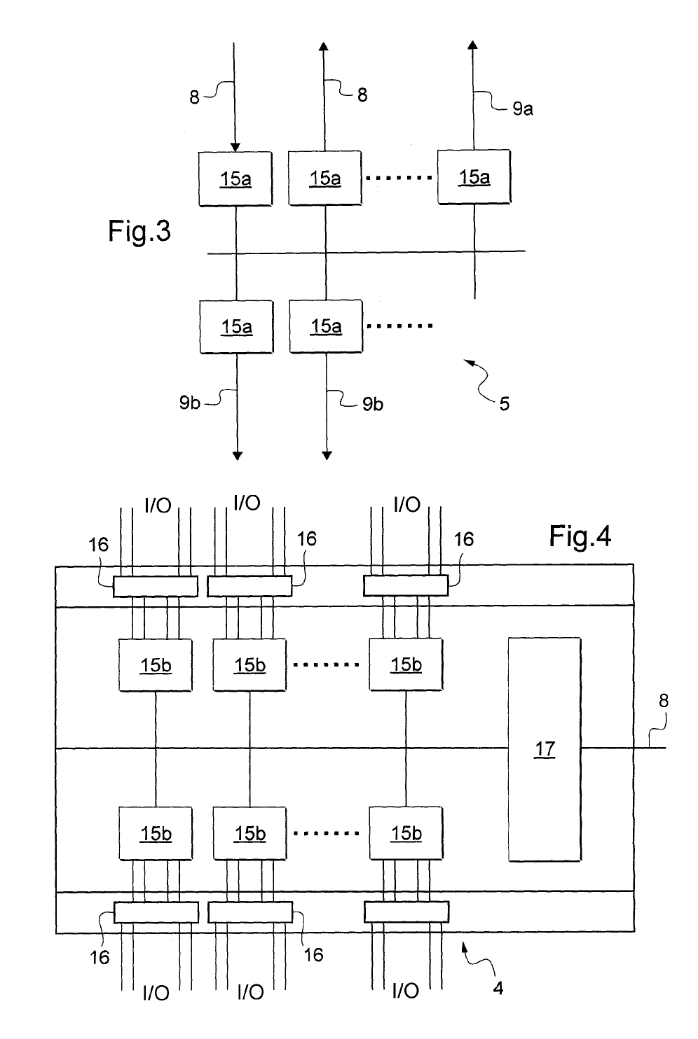

FIG. 3 is a diagrammatic illustration in greater detail of a gateway 5 of a communications network in accordance with the invention.

The gateway 5 includes modular elements in the form of configurable elementary and functional bricks 15a.

The gateway 5 is housed in protected zones of an aircraft, e.g. zones that are protected from shots, moisture, fire, strong electromagnetic fields, sand, and dust.

Each elementary and functional brick 15a serves to perform digital-to-digital conversion or to provide a digital type link between different types of digital bus 8, 9a, and 9b. This digital type link is identical for all of the modules constituting a given component.

FIG. 4 is a diagrammatic illustration in greater detail of a data concentrator 4 of a communications network in accordance with the invention.

The data concentrator 4 includes modular elements in the form of additional elementary and functional bricks 15b. These bricks are naturally configurable.

The data concentrator 4 is arranged as close as possible to the sensors 2 and the actuators 3 so as to reduce to as little as possible the amount of cabling required for establishing connections.

Each elementary and functional brick 15b of the data concentrator 4 is connected firstly to the first digital bus link 8 and secondly to an electrical adapter 16 having input/output connections I/O for the sensors 2 and the actuators 3, and also to an electrical adapter, if necessary, for analog or digital I/O. For the digital inputs/outputs I/O it is possible to use digital signals at different voltages, e.g. 24 V or 6 V.

Each elementary and functional brick 15b serves to perform digital-to-analog, analog-to-digital, or digital-to-digital conversion. The inputs/outputs I/O of each elementary and functional brick 15 are thus connected to a functional member such as a sensor 2 or an actuator 3.

The data concentrator 4 also includes a digital function block 17 incorporating the protocol of the digital bus 8, which protocol is standard such as ARINC or Ethernet.

An optional memory zone of the data concentrator 4 may serve, by way of example and where necessary, to store acquisition data for subsequent analysis and use of said stored data.

In order to explain differently the operation and the advantages of using a distribution gateway of the invention, it is emphasized that this distribution gateway includes modules that are distributed in the various pieces of equipment of the on-board network, i.e. the data concentrator, the computer, etc.

Configuration files serve to designate information for some other piece of equipment and they are copied using the distribution gateway in the equipment module that uses the information.

Thus, the role of each piece of equipment is solely to record the up-to-date data of the configuration files in its module or to use target data from the module, as though the module were an integral portion of the memory of said pieces of equipment (e.g. computers, data concentrators).

For the data concentrators 4, the configuration files comprise the list and the format of the acquired data coming from the sensors 2 or transmitted to the actuators 3, the type of digital bus or sending information to the gateways 5, and the format and the time sequence of the data transmitted over the selected digital bus.

For the gateways 5, the configuration files comprise the list and the format of input or output data together with the type of digital bus and its protocol.

The data concentrators 4 and the gateways 5 are preferably made up of solely of field-programmable gate arrays (FPGAs), etc. The FPGAs may receive the configuration files for a given avionics system via a digital type serial link 14. For each kind of data processed, these files include the parameters for configuring the processing actions associated with said data and that need to be performed by the component in question.

The communications network of a complete avionics system is thus constituted by computers 1, 1a, sensors 2, and actuators 3. The way in which these elements are connected together is implemented by identical subassemblies, each comprising data concentrators 4, digital buses 8, 9a, 9b, and gateways 5. The number of these subassemblies and their modular physical configuration depend on the type of the avionics system and/or of the mission. The generic functions provided by these subassemblies, e.g. exchanging information, modifying formats, or switching information, are configured by means of the configuration files.

The present invention thus relates to a novel avionics and/or mission architecture based on optimized distribution of functions between the components of an avionics system. In the context of the invention, this involves spreading processing loads between calculations done by calculating FPGAs and done by microprocessors, and on remotely locating modules in charge of data processing (format conversion and information switching).

The data concentrators 4, the digital buses 8, 9a, 9b, and the gateways 5 are thus configurable modular bricks that make it possible to construct an appropriate configuration for the communications network of an avionics system.

The invention may be subjected to numerous embodiments other than those described above.

What is claimed is:

1. A communications network for an avionics system on board an aircraft, the communications network conveying information between functional members including at least one on-board computer, sensors, and actuators, the network comprising links between said functional members, and communications interfaces between said links and said functional members, wherein between the links and said functional members, the communications network comprises:
at least one modular and configurable data concentrator for digitizing data from the sensors or for performing conversions, in particular digital-to-analog conversion of data concerning functional members or other digital-to-digital conversions, said data concentrator being arranged in the proximity of at least one functional member;
in a communications interface between at least one link of the communications network and at least one of said functional members at least one modular and configurable distribution gateway including functions of receiving, acquiring, changing digital format, and switching information, said distribution gateway being housed in a protected zone between said links of the communications network and said functional member in the proximity of said functional member;
in said communications interface, at least one first digital link forming a digital bus between the data concentrator and the distribution gateway; and
at least one second link via a digital bus between the distribution gateway and the on-board computer.

2. A communications network according to claim 1, including at least one wireless or carrier-current modulation link for connecting the distribution gateway to one or more control functional members.

3. A communications network according to claim 1, wherein the data concentrator includes modular elements in the form of configurable elementary and functional bricks.

4. A communications network according to claim 1, wherein the distribution gateway includes modular elements in the form of configuration elementary and functional bricks.

5. A communications network according to claim 3, including a database connected to the distribution gateway and to the data concentrator via a serial link of the digital type, said database being initialized with configuration files.

6. A communications network according to claim 1, wherein the digital buses are based on the ARINC 429, Mil Bus 1553, CAN bus, or Ethernet communications standards.
